(19) United States
(12) Patent Application Publication
(10) Pub. No.: US 2020/0375205 A1
(43) Pub. Date: Dec. 3, 2020

(54) SHELF STABLE SPORTS NUTRITION BEVERAGES MADE FROM DAIRY PERMEATE

(71) Applicant: GoodSport Nutrition LLC, Chicago, IL (US)

(72) Inventor: Michelle McBride, Glencoe, IL (US)

(73) Assignee: GoodSport Nutrition LLC, Chicago, IL (US)

(21) Appl. No.: 16/886,536

(22) Filed: May 28, 2020

Related U.S. Application Data
(60) Provisional application No. 62/854,936, filed on May 30, 2019.

(51) Int. Cl. A23C 9/142; A23L 33/18; A23L 33/125; A23L 33/16; A23L 2/68; A23L 2/46

(52) U.S. Cl. CPC A23C 9/1425; A23L 33/18; A23L 2/46; A23L 33/16; A23L 2/68; A23L 33/125

(57) ABSTRACT

A shelf stable hydration beverage can be prepared based on a dairy permeate.

### CLAIM OF PRIORITY

This application claims priority to U.S. Provisional Application No. 62/854,936, filed May 30, 2019, which is incorporated by reference in its entirety.

### FIELD OF THE INVENTION

The present disclosure relates to shelf stable sports nutrition beverages made from dairy permeate and methods of manufacturing a shelf stable sports nutrition beverages made from dairy permeate.

### BACKGROUND

Sports nutrition beverages are important health drinks for athletes and certain other populations.

### SUMMARY

This invention relates to shelf stable sports nutrition beverages made from a dairy permeate or dairy co-product and a method of creating shelf stable sports nutrition beverages from a dairy permeate or dairy co-product.

Athletes and certain other populations benefit from sports nutrition beverages because they provide certain nutritional benefits that may enhance performance and recovery from physical and athletic exertion.

For instance, proper hydration can be critical to optimal well-being and is exceptionally important when sweating is induced by strenuous exercise, heavy labor or physical activity in hot and humid temperatures. Traditional hydration beverages, often referred to as “sports drinks” contain electrolytes to ensure proper hydration and carbohydrates to provide fuel to active muscles and encourage fluid absorption. Milk can be rich in the electrolytes lost in sweat and contains an ideal ratio of carbohydrates to create an effective hydration beverage.

Dairy permeates can be generated when milk or whey is filtered by means of membrane filtration, such as ultra-filtration, microfiltration or other membrane system to remove milk proteins and fat. Whey is a liquid co-product of milk and is generated by separating the coagulum from milk, cream or skim milk in cheese making. Dairy permeates and whey contain a substantial portion of the electrolytes, vitamins and carbohydrates contained in milk. The discovery described herein can provide for shelf stable sports beverages made from dairy permeates or whey and a process of creating the invention.

In one aspect, a hydration beverage can include a dairy permeate or whey. The dairy permeate can be substantially lactose free and can have a sodium ion concentration of about 10-30 mMol/L, a chloride concentration of about 20-40 mMol/L, and an acidification agent. The beverage can have a pH of less than 3.60. The beverage can be made shelf stable through a hot fill process wherein the beverage is heated to at least 175 degrees F. and held at that temperature, for example, for less than 5 minutes and filled into containers while hot.

Recovery beverages are important health drinks that provide a source of protein to help athletes and other populations recover from the exertion of exercise. Hydration beverages contain electrolytes and carbohydrates to allow athletes to restore body fluids and prevent dehydration following exercise. Recovery beverages do not necessarily provide electrolytes and carbs to aid in rehydration and rehydration beverages do not generally provide protein to allow for recovery.

In another aspect, the present invention may provide for both so that the dual benefits of recovery and rehydration may be achieved in a single beverage. A recovery and rehydration beverage can include a dairy permeate, whey and/or a protein source. The dairy permeate can be substantially lactose free and can have a sodium ion concentration of about 10-30 mMol/L, a chloride concentration of about 20-40 mMol/L, and an acidification agent. The beverage can have a pH of less than 3.60. The dairy permeate or whey used in a recovery and rehydration beverage can have no protein, or may contain protein from milk. For example, the dairy permeate used in a recovery and rehydration beverage can be a milk permeate, whey permeate, microfiltered milk or whey may be used. The beverage can be made shelf stable through a hot fill process wherein the beverage is heated to at least 175 degrees F. and held at that temperature, for example, for less than 5 minutes and filled into containers while hot. The recovery and rehydration beverage is shelf stable.

In certain circumstances, the dairy permeate can be a liquid milk permeate (ultra-filtered deproteinized milk), whey permeate or microfiltered milk, otherwise known as native whey or whey, a dairy co-product.

In certain circumstances, the dairy permeate or whey is reconstituted from a concentrate.

In certain circumstances, the recovery and rehydration beverage will include a protein source.

In certain circumstances, the protein source can include whey protein isolate, whey protein, casein, soy protein, pea protein, insect protein, a plant-based protein or another protein source.

In certain circumstances, the protein source will be pre-acidified.

In certain circumstances, the recovery and rehydration beverage will include 20 grams of protein per serving. In certain circumstances, the recovery and rehydration beverage will include 10 grams of protein per serving. In certain circumstances, the recovery and rehydration beverage will include 35 grams of protein per serving. In certain circumstances, the recovery and rehydration beverage will include 50 grams of protein per serving.

In certain circumstances, the protein source will be completely soluble providing for a transparent beverage.

In certain circumstances, the pH of the sports beverage can be adjusted with an acidification agent.

In certain circumstances, the acidification agent can include an organic acid, for example, citric acid.

In certain circumstances, the citric acid can be used to lower the pH to less than 3.6, less than 3.5, less than 3.4, or less than 3.3.

In certain circumstances, the beverage can have a carbohydrate component concentration of 6 wt % or less.

In certain circumstances, the carbohydrate component can consist essentially of one disaccharide.

In certain circumstances, the disaccharide can be lactose.

In certain circumstances, the carbohydrate component can consist essentially of one or more monosaccharides.

In certain circumstances, the monosaccharides can be glucose, or glucose combined with galactose.

In certain circumstances, the carbohydrate concentration can be less than 5 wt %.

In certain circumstances, the beverage can include calcium, potassium, magnesium, chloride, thiamin, riboflavin, vitamin B5, vitamin B6 and biotin.

In certain circumstances, the beverage can include an added sweetener, for example, a non-caloric sweetener, for example, stevia, monk fruit extract, aspartame and/or erythritol. The sweetener can be from an artificial, natural and/or organic source.

In certain circumstances, the sodium ion in the beverage can come from added sodium. For example, the beverage can include sodium added to the beverage as a sodium salt. The beverage can have one or more of a sodium ion concentration of about 20-50 mMol/L and a chloride concentration of about 20-40 mMol/L.

In certain circumstances, the beverage can have a potassium ion concentration of about 20-30 mMol/L.

In certain circumstances, the beverage can have a calcium ion concentration of about 1-10 mMol/L.

In certain circumstances, the beverage can have a magnesium ion concentration of about 1-10 mMol/L.

In certain circumstances, the beverage can have a phosphorous concentration of about 1-20 mMol/L.

In certain circumstances, the beverage can include iodine, chromium ion, selenium, thiamin, riboflavin, vitamin B5, vitamin B6, vitamin B12, biotin and folate.

In certain circumstances, the pH of the recovery and rehydration beverage can be adjusted with an acidification agent. In certain circumstances, the acidification agent can include an organic acid, for example, citric acid.

In certain circumstances, the beverage can have a carbohydrate component concentration of 6 wt % or less.

In certain circumstances, the sodium ion in the beverage can come from added sodium. For example, the beverage can include sodium added to the beverage as a sodium salt. In another aspect, a method of making a hydration beverage can include providing a dairy permeate and/or adding a sodium salt to the dairy permeate, and adding an acidification agent. The beverage can have one or more of a sodium ion concentration of about 10-50 mMol/L or about 20-50 mMol/L, a chloride concentration of about 20-40 mMol/L, a carbohydrate component concentration of 6 wt % or less, and a pH of less than 3.60. The beverage pH can be lowered to less than 3.60. The beverage can be heat pasteurized to provide shelf stability for several months or years.

In certain circumstances, the dairy permeate is reconstituted from a liquid or dry concentrate.

In certain circumstances, the dairy permeate can be a milk permeate or a whey permeate.

In certain circumstances, the beverage can have a carbohydrate component concentration of 6 wt % or less. In certain circumstances, the carbohydrate component can consist essentially of one or more monosaccharides.

In certain circumstances, the monosaccharides can be glucose, or glucose combined with galactose.

In certain circumstances, the carbohydrate concentration can be less than 5 wt %.

In certain circumstances, the dairy permeate is substantially free of protein.

In certain circumstances, the dairy permeate can contain whey protein.

In certain circumstances, the total solids content of the beverage can be less than 20 wt %.

In certain circumstances, the beverage can have a potassium ion concentration of about 20-30 mMol/L.

In certain circumstances, the beverage can have a calcium ion concentration of about 1-10 mMol/L.

In certain circumstances, the beverage can have a magnesium ion concentration of about 1-10 mMol/L.

In certain circumstances, the beverage can have a phosphorous concentration of about 1-20 mMol/L.

In certain circumstances, the beverage can include iodine, chromium ion, selenium, thiamin, riboflavin, vitamin B5, vitamin B6, vitamin B12, biotin and folate.

In certain circumstances, the beverage can include an added sweetener, for example, a non-caloric sweetener, for example, stevia, monkfruit, or erythritol or combinations thereof

In certain circumstances, the beverage can have a total solids content of at least 5 wt %.

In certain circumstances, the beverage can be heated to a minimum of 175 degrees during manufacture.

In certain circumstances, the method can include concentrating the dairy permeate.

The shelf stable sports nutrition beverage can have a number of unexpected advantages.

Others have tried to show that a shelf-stable electrolyte beverage could be made from milk permeate. However, these approaches would present challenges in producing a useful shelf stable sports nutrition beverage. For example, in contrast to others, the shelf stable sports nutrition beverage described herein has a pH level of less than 3.6 to ensure stability. Unexpectedly, it was demonstrated that a dairy permeate beverage that is heat treated at pH 3.6 or higher falls apart with calcium and other mineral components precipitating, leaving a thick sandy residue at the bottom of the container and, as a result, the beverage is not shelf stable.

Another meaningful difference relates to the hot fill heat process that can be used to create a shelf stable product. In the shelf stable sports nutrition beverage described herein, the beverage can be heated to a minimum of 175 degrees F., and filled into containers while hot. The containers can be held for a minimum of 30 seconds at 170 degrees F. (77 C.) but not longer than 4 minutes. In certain embodiments, the temperature can be held for not longer than 3 minutes, and in other embodiments, no longer than 2 minutes. A dairy permeate beverage that is heat treated at 85 degrees for 5 minutes or longer will fall apart with components precipitating, and as a result the beverage is not shelf stable. Furthermore, heating a dairy permeate beverage to 85 degrees Celsius and holding it at that temperature for five minutes, can produce flavor off-notes giving the drink an undesirable taste.

Another difference is the degree of hydrolysis of lactose. In the beverage described herein, the lactose is hydrolyzed 100% so that less than 0.05%, less than 0.02% or less than 0.1% lactose remains in the beverage. Others only hydrolyzed 80% of the lactose, leaving 20% of the lactose intact. The more complete hydrolysis not only makes it easier for lactose intolerant consumers to digest, but it also increases sweetness, improves fluid absorption into the bloodstream (hydration) and provides a more readily available source of energy for working muscles. An upper limit to the amount of carbohydrate to be used can improve these benefits because too much carbohydrate can inhibit fluid absorption. Alternatively, the beverage does not need to be hydrolyzed at all leaving 100% of the lactose intact as the sole source of carbohydrate

In addition to differences in the beverage, there are important differences in the method of manufacture described here and the methods described by others. For example, the method can include a hot fill process whereby the bottle is then filled at approximately 175 degrees F. and held in the bottle for 90 seconds ensuring that the bottle temp stays above 170 for the duration of the 90 seconds before the bottle is cooled in order to maintain the shelf stability of the beverage.

Another difference is the amount of added sodium. In the beverage described herein, added sodium hits a range of 20-50 mmol/L or 20-50 mEqL. Specifically, the beverage described herein contains 21 mmol/L/21 mEqL. Others do not add additional sodium therefore, the beverage would not provide enough sodium to encourage absorption of fluids.

Yet another difference relates to sweeteners. The beverage described herein uses non-caloric sweetener, however in some applications, a caloric sweetener might be helpful to add to the beverage.

Moreover, the beverage described here targets athletes that need a certain level of carbohydrate content to improve performance but an effective beverage can't contain too much carbohydrate because it affects gastric emptying and fluid absorption. The beverage described herein has carbohydrate levels that do not exceed 6%, specifically the beverage described herein has a carbohydrate content of 3.7%.

Others have tried to show that a beverage could be made from whey permeate. However, the approach does not provide for a shelf stable product.

Another difference is in the beverage herein an acidification agent has been added, namely citric acid, to reduce the pH to less than 3.6. This contrasts with other beverages that have a pH of 6.3-6.8.

Another difference is the amount of potassium in the . In the beverage herein, potassium levels are 26.5 mMol/L. Others dilute the permeate to lower the level of potassium.

Another difference relates to the process of formulating the beverage. In the beverage herein, the beverage is formulated from liquid dairy permeate that has never been dried. Others have dried their permeate and reconstituted it with water.

Moreover, the beverage described herein is shelf stable for months (for example, 1 month, 2 months, 3 months, 4 months, 5 months or 6 months) or years and does not require refrigeration. The other beverage requires refrigeration.

In another aspect, a shelf stable sports nutrition beverage made from a dairy permeate may include a protein source to help athletes and certain other populations recover from strenuous physical activity. The dairy permeate can be substantially lactose free and can have a sodium ion concentration of about 10-30 mMol/L, a chloride concentration of about 20-40 mMol/L, and an acidification agent. The beverage can have a pH of less than 3.60. The beverage can be made shelf stable through a hot fill process wherein the beverage is heated to at least 175 degrees F. and held at that temperature, for example, for less than 5 minutes and filled into containers while hot.

In certain circumstances, the dairy permeate can be a liquid milk permeate (ultra-filtered deproteinized milk), whey permeate or microfiltered milk (native way) or whey.

In certain circumstances, the dairy permeate or whey is reconstituted from a liquid concentrate.

In certain circumstances, the protein source can include whey, whey protein concentrate, whey protein isolate, casein, plant protein, soy protein, pea protein, insect protein or another protein source.

In certain circumstances, the protein source will be pre-acidified.

In certain circumstances, the recovery and rehydration beverage will include 20 grams of protein per serving. In certain circumstances, the recovery and rehydration beverage will include 10 grams of protein per serving. In certain circumstances, the recovery and rehydration beverage will include 50 grams of protein per serving.

In certain circumstances, the protein source will be completely soluble providing for a transparent beverage.

In certain circumstances, the citric acid is used to lower the Ph to less than 3.6. Less than 3.5, Less than 3.4, Less than 3.3.

Other have tried to show that a protein drink can be made with a dairy permeate. However, these approaches would present challenges in producing a shelf stable recovery and rehydration beverage.

For example, in contrast to others, the recovery and rehydration beverage herein has a pH level of less than 3.6 to ensure stability and to allow for a hot fill pasteurization process. Others have made a protein drink by adding protein to whey permeate to create a beverage that must be refrigerated. Additionally, the protein used was hypoallergenic. Further, the beverage was not transparent to provide refreshing recovery.

Other aspects, embodiments, and features will be apparent from the following description, the drawings, and the claims.

### DETAILED DESCRIPTION OF THE INVENTION

The idea for the shelf stable sports nutrition beverages described herein developed from the concept of leveraging the nutritional components of milk to develop healthy sports nutrition beverage options that can provide optimal hydration and/or recovery with superior taste.

Milk has been shown to be more hydrating than a leading sports drink and water because milk has a high electrolyte content and is a natural source of carbohydrate. When milk is ultra-filtered and its proteins removed, a nutrient-rich transparent liquid is generated, also known as milk permeate or ultra-filtered deproteinized milk and with it can be developed sports nutrition beverages with a light and refreshing mouth feel athletes prefer before, during and after hot and sweaty occasions.

Milk permeate or ultra-filtered deproteinized milk can be used to create a highly effective hydration beverage to be consumed before, during or after strenuous exercise or athletic competition and if protein is added to the beverage, it can be consumed for recovery and rehydration following strenuous exercise or athletic competition.

For instance, a hydration beverage can be made and will supply essential electrolytes including, for example, sodium, potassium, calcium, phosphorus, chloride, and magnesium. The hydration beverage also can be a good or excellent source of B Vitamins and can provide naturally occurring carbohydrates to provide fuel for working muscles. The hydration beverage can be lactose-free, non-GMO, gluten-free and can contain no added sugar. The hydration beverage can be made with only natural flavors, colors and sweeteners and may not contain preservatives.

In certain examples, the hydration beverage can be provided in a 16.9 oz recyclable bottle in popular sports drink flavors including but not limited to lemon-lime, fruit punch, wild berry and citrus.

The hydration beverage is scientifically formulated to meet the following six critical objectives of an effective sports drink:
Encourage voluntary fluid consumption
Stimulate rapid fluid absorption
Optimize hydration during exercise
Speed rehydration after exercise
Support cardiovascular function during physical activity
Supply carbohydrates for improved performance

The beverage has been developed based on a significant research and development period and consumer testing. One objective when developing the beverage was to provide a drink for consumption before, during and after exercise or other physical activity that is made with natural ingredients with no artificial flavors, colors or sweeteners. The beverage harnesses electrolytes, vitamins and carbohydrates naturally occurring in milk to deliver superior hydration but the beverage does not taste like milk or go down like milk because many people don't find milk refreshing especially during hot and sweaty occasions.

The process was developed in which proteins were first removed from the milk because milk proteins cause milk's thick mouthfeel and these protein components are unnecessary to promote superior hydration. Further, while milk proteins are high quality proteins desirable in other applications, including dietary use, in a hydration beverage, the proteins can lead to performance-reducing gastric distress if consumed while exercising.

Thus, the process for producing the hydration beverage includes a step of removing the proteins from the milk. For example, ultrafilters can be used to remove the protein molecules from milk. No additives or other unnatural processing steps are needed. The resulting extract is a transparent, light liquid that contains electrolytes, vitamins and carbohydrates to make a superior hydration beverage. Proteins may also be removed from milk by using additives.

This helps create a hydration beverage that is easy to digest, which is an important factor in creating an effective sports drink. Thus, the hydration beverage is also made lactose-free. Lactose, a sugar that naturally occurs in milk, is a disaccharide that can be difficult for some people to digest. In the process of preparing the hydration beverage described herein, the lactose is completely hydrolyzed with the addition of lactase enzyme, wherein the lactase enzyme breaks the disaccharide down into its two monosaccharaides or simple sugars (i.e., glucose and galactose). This simplification of the structures in the hydration beverage ensures that the hydration beverage is easy to digest. The hydrolysis of the lactose provides two other advantages in addition to easier digestion. The presence of the two different kinds of monosaccharide carbohydrates: 1) improves fluid absorption and; 2) provides more easily accessible fuel for working muscles. Alternatively, the hydration beverage can be formulated using lactose as its carbohydrate component thus the addition of lactase enzyme would be unnecessary.

The hydration beverage has other advantages over other drinks. The hydration beverage contains more electrolytes than leading sports drinks.

The hydration beverage described herein contains not only an optimal level of sodium but also contains 26.5 mMol/L potassium. And the hydration beverage provides other electrolytes—including 10% DV calcium, which is not present in other sports drinks.

The hydration beverage also includes B vitamins. The hydration beverage is a source of Vitamin B6, Vitamin B5, Thiamin (B1), Riboflavin (B2) and/or Biotin (B7).

The hydration beverage can be a controlled source of calories. For example, one 16.9 oz bottle of the hydration beverage contains 90 calories to fuel working muscles. Other sports drinks contain higher levels of calories. The hydration beverage provides a balanced combination of calories, electrolytes, simple sugars and vitamins.

The hydration beverage can contain no added sugars. As discussed above, the naturally occurring carbohydrates in milk can be used as fuel. To provide an optimal sweetness level, the sweetness level can be adjusted and optimized, for example, for sweaty athletes, by further sweetening the hydration beverage with a blend of the zero-calorie natural sweeteners such as stevia, monk fruit, erythritol or an artificial sweetener, for example, aspartame. The sweetener can be from an organic source.

The hydration beverage can include target amounts of the critical components to optimize hydration, electrolyte balance and other health and nutrition factors.

The hydration beverage can be manufactured using sustainable methodologies. Purchasing milk and filtering it to remove the proteins could be a wasteful and costly endeavor. Cheese and dairy ingredient manufacturers remove protein from milk to create dairy ingredients such as cheese or milk protein concentrates. In doing so, they generate ultra-filtered deproteinized milk, also known as milk permeate, one form of dairy permeate. This ultra-filtered deproteinized milk or milk permeate produced by this industry can be generated in the ordinary course of business by the ton every day, and disposing of it can be a source of significant financial and environmental cost.

The hydration beverage described herein can present a solution to this problem by transforming dairy industry waste into a consumer product of value. By doing so, the environmental impact of tons of waste is reduced and transformed into a direct financial benefit to the dairy industry.

In general, the hydration beverage can have the following ingredients: ultra-filtered deproteinized milk (for example, milk permeate), erythritol, sea salt, vegetable juice (for color), monk fruit, citric acid, lactase enzyme, and natural flavor.

The hydration beverage includes a pH control composition that helps stabilize the components in the beverage. The pH control composition can be an acidification agent. In the absence of pH control, the composition of the hydration beverage can destabilize, leading to precipitation of critical components of the beverage. Specifically, calcium-containing components, for example, calcium phosphate, or magnesium-containing components, as well as other mineral components, can precipitate from the hydration beverage. By adding a pH control composition to the hydration beverage, the stability and shelf life of the hydration beverage can be improved. By adding a pH control composition to the hydration beverage it can be heat pasteurized in a hot fill process to make the beverage shelf stable for months or years once produced. The pH control composition can be an organic acid, for example, a citric acid or citrate buffer. In certain embodiments, the pH of the hydration beverage can be less than 4.00 or less than 3.80. In other embodiments, the pH of the hydration beverage can be less than 3.60, less than 3.50, less than 3.40, greater than 2.5, greater than 2.80, or greater than 3.0. For example, the pH of the hydration beverage can be between 3.00 and 3.70, between 3.20 and 3.65, or between 3.50 and 3.60. In certain embodiments the pH of the hydration beverage can be less than 3.50 or 3.40.

In one aspect, for example, a hydration beverage can include a dairy permeate, wherein the dairy permeate is substantially lactose free, a sodium ion concentration of about 10-50 mMol/L, a chloride concentration of about 10-50 mMol/L, and an acidification agent. The beverage can have a pH of less than 3.60.

In one aspect, for example, a hydration beverage can include a dairy permeate, wherein 100% of the lactose is kept intact.

The sodium ion concentration can be less than 1000 ppm, less than 800 ppm, less than 600 ppm, less than 500 ppm, more than 100 ppm, more than 200 ppm, more than 300 ppm, or, for example, about 300-500 ppm. In certain circumstances, sodium ion concentration can be less than 50 mMol/L, less than 28 mMol/L, less than 26 mMol/L, less than 24 mMol/L, less than 22 mMol/L, greater than 10 mMol/L, greater than 12 mMol/L, greater than 14 mMol/L, greater than 16 mMol/L, or greater than 18 mMol/L, for example, 10-30 mMol/L.

The chloride concentration can be less than 2000 ppm, less than 1800 ppm, less than 1600 ppm, less than 1500 ppm, more than 100 ppm, more than 200 ppm, more than 500 ppm, or more than 800 ppm, or, for example, about of about 800-1200 ppm. In certain circumstances, sodium ion concentration can be less than 40 mMol/L, less than 36 mMol/L, less than 32 mMol/L, less than 32 mMol/L, greater than 10 mMol/L, greater than 12 mMol/L, greater than 14 mMol/L, greater than 16 mMol/L, or greater than 18 mMol/L, for example, 20-40 mMol/L.

In certain circumstances, the pH of the hydration beverage can be adjusted with an acidification agent. In certain circumstances, the acidification agent can include an organic acid, for example, citric acid, acetic acid, tartaric acid, malic acid or carbonic acid.

In certain circumstances, the dairy permeate is reconstituted from a liquid concentrate.

In certain circumstances, the dairy permeate can be a milk permeate, a whey permeate or microfiltered milk.

In certain circumstances, the beverage can have a carbohydrate component concentration of 20 wt % or less, 15 wt % or less, 12 wt % or less, 10 wt % or less, 8 wt % or less, or 6 wt % or less. In certain circumstances, the beverage can have more than 1 wt %, or more than 2 wt %. In certain circumstances, the beverage can be calorie free. In certain circumstances, the carbohydrate component can consist of essentially monosaccharides. The monosaccharides of the carbohydrate component do not include non-caloric carbohydrates, which can be included for sweetness or other organoleptic properties.

In certain circumstances, the carbohydrate concentration can be less than 10 wt %, less than 8 wt % or less than 5 wt %, or greater than 1 wt %

In certain circumstances, the dairy permeate is substantially free of protein. For example, the milk or whey permeate can include less than 2%, less than 1% or less than 0.5% protein, or greater than 0.2% protein.

In certain circumstances, the total solids content of the beverage can be less than 30 wt %, less than 25 wt %, less than 20 wt %, less than 15 wt %, or less than 10 wt %, or greater than 2 wt %.

In certain circumstances, the beverage can have a potassium ion concentration of less than 2000 ppm, less than 1800 ppm, less than 1600 ppm, less than 1500 ppm, more than 100 ppm, more than 200 ppm, more than 500 ppm, or more than 800 ppm, or, for example, about 1000-1400 ppm. In certain circumstances, potassium ion concentration can be less than 40 mMol/L, less than 36 mMol/L, less than 32 mMol/L, less than 32 mMol/L, greater than 10 mMol/L, greater than 12 mMol/L, greater than 14 mMol/L, greater than 16 mMol/L, or greater than 18 mMol/L, for example, 20-30 mMol/L.

In certain circumstances, the beverage can have a calcium ion concentration of less than 1000 ppm, less than 800 ppm, less than 600 ppm, less than 500 ppm, more than 100 ppm, more than 200 ppm, or, for example, about 200-400 ppm. In certain circumstances, calcium ion concentration can be less than 30 mMol/L, less than 26 mMol/L, less than 22 mMol/L, less than 15 mMol/L, greater than 0.10 mMol/L, greater than 0.5 mMol/L, or greater than 0.75 mMol/L, for example, 1-10 mMol/L.

In certain circumstances, the beverage can have a magnesium ion concentration of about less than 500 ppm, less than 400 ppm, less than 300 ppm, less than 200 ppm, more than 100 ppm, more than 20 ppm, more than 40 ppm, or more than 50 ppm, or, for example, about 60-100 ppm. In certain circumstances, magnesium ion concentration can be less than 30 mMol/L, less than 26 mMol/L, less than 22 mMol/L, less than 15 mMol/L, greater than 0.10 mMol/L, greater than 0.5 mMol/L, or greater than 0.75 mMol/L, for example, 1-10 mMol/L.

In certain circumstances, the beverage can have a phosphorous concentration of less than 1000 ppm, less than 800 ppm, less than 600 ppm, less than 500 ppm, more than 50 ppm, more than 100 ppm, more than 200 ppm, or more than 300 ppm, or, for example, about 300-500 ppm. In certain circumstances, phosphorus concentration can be less than 30 mMol/L, less than 26 mMol/L, less than 22 mMol/L, greater than 0.10 mMol/L, greater than 0.5 mMol/L, or greater than 0.75 mMol/L, for example, 1-20 mMol/L.

In certain circumstances, the beverage can include one or more of thiamin, riboflavin, vitamin B5, vitamin B6, vitamin B12 or biotin.

In certain circumstances, the beverage can include an added sweetener, for example, a non-caloric sweetener, for example, stevia, monkfruit, and/or erythritol.

In certain circumstances, the beverage can have a total solids content of at least 1 wt %, at least 5 wt % or at least 10 wt %.

In certain circumstances, the beverage can be heated to greater than 80 degrees C., greater than 85 degrees C., greater than 90 degrees C., or 175 degrees F. during manufacture.

In certain circumstances, the method can include concentrating the dairy permeate.

More specifically, the hydration beverage can have the following attributes and can be prepared in the following way.

Proper hydration is critical to optimal physiological function and over all wellbeing. Proper hydration becomes exceptionally important before, during and after exercise for competitive sport, recreation in hot and humid temperatures or physically demanding occupational settings where water loss can negatively affect performance, cause early fatigue and impair decision making.

The loss of water due to thermoregulatory sweating is accompanied by loss of electrolytes with the predominant electrolyte lost in sweat being sodium. Other electrolytes lost in sweat include: potassium, calcium, magnesium, chloride and phosphorus.

What is a Hydration Beverage

A hydration beverage, also referred to as a “sports drink” is a beverage designed for consumption before, during or after strenuous exercise, physical exertion or athletics, and which typically contains carbohydrates and electrolytes such as sodium, chloride, magnesium and potassium to improve fluid absorption and retention. Carbohydrates also serve to restore energy.

What is an Electrolyte

An electrolyte can be defined as a compound that dissociates into ions when in solution. The major cations (positively charged electrolytes) in the body water are sodium, potassium, calcium and magnesium. The major anions (negatively charged electrolytes) are chloride and bicarbonate. Each electrolyte has a specific physiologic function and loss of each electrolyte can impact the physical condition of an individual. Sodium is the major electrolyte present in the extracellular fluid, while potassium is present in a much lower concentration. In the intracellular fluid the situation is reversed, and the major electrolyte present is potassium, with sodium found in much lower concentrations. It is critical for the body to maintain this distribution of electrolytes because maintenance of the transmembrane electrical and chemical gradients is of paramount importance for assuring the integrity of cell function and allowing electrical communication throughout the body.

Sodium is the predominant electrolyte lost in sweat. Sodium and its conjugate anions (chloride and bicarbonate) comprise the most osmotically active components of the extracellular fluid. Consequently, sodium balance plays a key role in governing the size of the extracellular fluid compartment and passive water movement according to osmotic gradients between the intracellular and extracellular water spaces. Thus, sodium and chloride are the key electrolytes for maintaining fluid volume in the bloodstream, an important component of proper hydration.

Dairy Permeate Ideal for Creating a Hydration Beverage

Milk has been found to be an effective hydrator because it provides a rich supply of electrolytes including: sodium, chloride, potassium, calcium, magnesium, and phosphorus.

Milk contains higher levels of electrolytes than most traditional sports drinks and has been found to be more hydrating than traditional sports drinks and water. However, the protein and fat in milk can cause performance reducing gastric distress when consumed while physically active and consumers generally don't find milk to be a thirst quenching beverage on hot and sweaty occasions thus preventing an adequate volume of milk from being consumed to maintain adequate hydration.

The protein and fat can be removed from milk or whey through a process of ultra-filtration. When the fat and protein is removed through ultra-filtration, the liquid that remains is referred to as permeate. The permeate is rich in electrolytes, carbohydrates and vitamins.

What is a Dairy Permeate

Purchasing milk and filtering it to remove the proteins could be a wasteful and costly endeavor. Cheese and dairy ingredient manufacturers remove protein and fat from milk and/or whey to create dairy ingredients such as milk protein concentrate or use it to standardize protein levels in their cheeses. The protein portion that these manufacturers retain is called retentate. The byproduct that is generated is referred to as permeate.

There are three types of dairy permeates created from the filtering of milk or whey: milk permeate; created by the ultrafiltration of milk; microfiltered milk also known as native whey or milk-derived whey, created from the microfiltration of milk and whey permeate; created following the ultrafiltration of whey.

All three types of dairy permeates are generated as a by-product during the dairy ingredient and/or cheese making manufacture process and have little economic value. They are generally disposed of or used as animal feed though they may be dried and their constituent parts sold as ingredients.

Milk permeate is created as a result of the ultrafiltration of milk. The protein is separated and isolated from milk with ultrafiltration whereby skim or whole milk is passed through an ultrafiltration system using a membrane having a molecular weight size exclusion of approximately 10 kDa or lower. The liquid byproduct remaining after ultrafiltration, is milk permeate.

Milk permeate retains significant quantities of milk's electrolytes, vitamins and carbohydrate. It is a transparent liquid that has as light mouthfeel and a clean neutral milk taste. Milk permeate will maintain that light clean taste if it is handled and processed as outlined herein.

Whey permeate is created as a result of the ultrafiltration of whey. Cheese is made when enzymes, typically chymosin, and lactic acid forming bacteria are added to milk causing it to coagulate and form curds. The curds are separated and made into cheese. The remaining liquid, called whey contains lactose, whey protein, water, minerals, vitamins and some fat. The whey is then filtered through an ultrafiltration membrane to remove the remaining protein and fat using a membrane having a molecular weight size exclusion of approximately 10 kDa or lower. The liquid that remains following ultrafiltration is whey permeate.

Whey permeate retains a significant amount of the lactose, minerals and vitamins found in milk. Whey permeate is also a transparent liquid with a light mouthfeel. Whey permeate has a slightly cheesy taste, though it may be sweetened and flavored to cover the cheesy taste to provide a flavor profile appropriate for the formulation of a hydration beverage. Notably, the taste of whey permeate will degrade rapidly following production due to the presence of the enzymes and lactic acid bacteria that are introduced to curdle the milk. Thus, proper handling is required as outlined below.

Native whey or milk-derived whey, is created from the microfiltration of milk. The whey protein is separated and isolated from milk with microfiltration whereby skim or whole milk is passed through an microfiltration system allowing the casein protein to remain.

The growth of microorganisms in dairy permeates causes the development of acid which in turn lowers the permeates' pH level. Even a slight change in pH level will negatively affect the taste of permeate. The pH of fresh dairy permeate is that of milk, typically in a range of 6.5-6.8. Milk permeate and microfiltered milk will maintain a pH of 6.5-6.8 for several days if measures are taken to prevent contamination and if temperatures of the milk permeate remain below 45 degrees F. Whey permeate, because it contains the bacteria used in curdling, must be pasteurized almost immediately following ultrafiltration. Whey permeate must then remain below 45 degrees F. to prevent contamination.

The collection and storage of the dairy permeate prior to its processing into a hydration beverage is a critical component of the overall process of the invention. All permeates can be created outside of the cheese making or dairy ingredient manufacture process if an ultrafiltration or microfiltration unit is used for the purpose of removing the proteins to create a beverage. Because dairy permeates are created as a byproduct of another primary process, i.e. cheese making, and not produced as a primary ingredient themselves, oftentimes proper storage and/or handling measures are not taken to ensure the quality of the permeate.

Collection of Milk Permeate

In a commercial setting, milk is used in the creation of milk permeate. Milk is passed through an ultrafiltration unit and its parts separated. The protein is used to create dairy ingredients such as milk protein concentrate or to standardize cheese. The milk permeate is run through lines usually to a holding tank where it can then be collected and removed.

To ensure the milk permeate is not contaminated and the pH maintained, good manufacturing processes must be practiced to produce a permeate that has low enough bacterial counts for it to be used as an ingredient. Therefore, all lines and holding apparatus used to move and store the milk permeate must be sanitized and rinsed with potable water including all lines from the pasteurized milk whether that be directly from the milk pasteurizer or a holding tank to the ultrafiltration unit, the ultrafiltration unit and its membranes, the lines from the ultrafiltration unit to the holding tank, the holding tank itself as well as any spigots or any other ancillary parts that come in contact with the milk permeate.

Once generated, the milk permeate must be kept at a temperature below 45 F. It must remain at temperature during the collection, transport and storage of the permeate prior to being processed into a hydration beverage and heat treated for shelf stability.

Collection of Whey Permeate

In a commercial setting, milk is used in the creation of whey permeate. The milk is treated with bacteria and enzymes to initiate the curdling process required for cheese making and the cheese curds are removed and made into cheese. The remaining liquid whey is then passed through an ultrafiltration membrane with a molecular weight size exclusion of 10 kDa or lower. The ultrafiltration process removes residual whey protein which is then piped to an area in the dairy plant for further processing. The resultant whey permeate is generally piped to a holding tank where it can be collected and removed.

The lactic acid causing bacteria in the whey permeate will start to grow almost immediately following ultrafiltration thus a process for immediate batch pasteurization or preferably continuous pasteurization directly from the ultrafiltration system should be initiated onsite.

The temperature of the pasteurized whey permeate must be kept under 45 F. It must remain at that temperature during collection and transport prior to being processed into a hydration beverage and further heat treated for shelf stability.

Concentration of Dairy Permeate:

For ease of transport and the ability to standardize the carbohydrate and/or mineral or vitamin content of the hydration beverages, dairy permeates may be concentrated. The average total solids of milk permeate is approximately 5.8% comprised of lactose (4.9%) non-protein nitrogen (approximately 0.25%) and ash* (0.45%). The average total solids for whey permeate is also approximately 5.8% with a similar breakdown lactose (4.1-4.9%), non-protein nitrogen (0.3-0.4%), ash (0.05-0.07%) and lactic acid (0.5-0.15%). *ash means minerals

Dairy permeates may be concentrated through a process of reverse osmosis. Reverse osmosis is a system that uses a partially permeable membrane to remove ions, molecules and large particles from water with an applied pressure to overcome osmotic pressure allowing water to pass through the membrane. Commercially available reverse osmosis membranes may also be used to remove part but not all of the water from dairy permeates creating higher total solids concentrations.

During the process of creating a hydration beverage from dairy permeate, water may be added to the concentrate to reconstitute the permeate back to its original total solids levels or to a custom total solids level to ensure standardization of carbohydrate or caloric content, or standardization of a mineral or vitamin content.

For example, concentrated dairy permeate can be reconstituted to create a dairy permeate base with 4% lactose creating a beverage base with 16 calories per 100 g or it can be reconstituted to create a dairy permeate base with 8% lactose creating a beverage base with 32 calories per 100 g. Similarly, concentrated dairy permeate can be reconstituted to create a dairy permeate base with 30 mg calcium per 100 g or to 60 mg calcium per 100 g. Customized concentrations of other vitamins or minerals may also be achieved.

Dry Permeate:

Commercially available spray dryers or evaporators are available allowing for dairy permeate to be dried to a moisture content of 4-6%. As with concentrated liquid dairy permeate, dried or evaporated dairy permeate may then be reconstituted to custom levels with water prior to formulating the hydration beverage.

Process for Making Hydration Beverage

Hydrolyze/Intro to Carbohydrate

To prepare an effective shelf stable hydration beverage from dairy permeate, the permeate in liquid format, either concentrated or non-concentrated, can be hydrolyzed with lactase enzyme to break down the disaccharide lactose into to its two monosaccharide components, glucose and galactose. Hydrolysis is complete when lactose levels are low enough to read <0.1% in the finished product. The shelf stable hydration beverage can also be made without hydrolyzing the lactose.

Dairy permeate that has been concentrated in liquid form can be hydrolyzed either before or after reconstitution. Dried permeate will have to be reconstituted prior to hydrolysis as the lactase enzyme works only in liquid form.

The availability of the carbohydrate as two monosaccharides as opposed to a single disaccharide not only provides a more easily digestible carbohydrate source for consumers who are lactose intolerant but also provides two additional benefits critical in the formulation of a hydration beverage: the promotion of fluid absorption and a more efficient energy source for working muscles.

Providing a blend of carbohydrate types is important to optimize fluid absorption. Activation of multiple transport mechanisms plays an important role in optimizing carbohydrate delivery and promoting fluid absorption in the small intestine. The combination of glucose and galactose stimulate the activity of the SGLT-1 membrane bound transporter in the epithelium of cells in the proximal small intestine, ensuring rapid absorption of those two carbohydrates. Further, activation of the SGLT-1 transport system stimulates transcellular and paracellular transport of other electrolytes and water providing for improved fluid absorption.

Sports drinks improve exercise performance, i.e., the capacity to exercise longer, harder, or faster, by reducing the negative effects of dehydration and by providing carbohydrate energy that active muscles are well designed to use. It is now well established that exogenous carbohydrate can be oxidized during exercise and that exercise performance is improved as a result.

Research also shows that a mixture of carbohydrates is better than a single carbohydrate for both rapid absorption into the bloodstream and for improving performance of working muscles. Both glucose and galactose are absorbed by the same SGLT-1 transporter in the membrane of the small intestine. Both travel from the small intestine to the liver. Most glucose is released by the liver while most galactose remains in the liver to be converted to glucose which can then be released into the bloodstream or stored in the liver as glycogen for future use. Ingesting multiple types of carbohydrates during exercise is associated with better performance, lower ratings of perceived exertion, and less gastrointestinal distress compared to ingesting drinks containing only one carbohydrate.

Lowering of the pH/Acidifying

Once the dairy permeate has been reconstituted and properly hydrolyzed as outlined above, the pH is then lowered below pH 3.6 with citric acid or a similar acidifying agent such as malic acid, phosphoric acid, tartaric acid, lactic acid, sodium acid sulfate or with another pH reducing acid or acidulant. After the pH has been lowered to a level <3.6, the beverage can be heat pasteurized. If the permeate is allowed to remain at a pH level at 3.6 or above, the heat applied during the pasteurization process will cause minerals such as calcium and magnesium from the permeate to become insoluble and fall out as precipitate.

There are four reasons for acidifying the dairy permeate to a pH level of <3.6: 1) to ensure the stability of the beverage; 2) to provide the right balance of tartness to improve voluntary fluid intake; 3) to arrest microbial growth; and 4) allow for lower temperature heat pasteurization which helps further ensure the stability of the calcium and other mineral components.

Beverage Stability

While sodium is the primary electrolyte required for optimal hydration, there is no question that the presence of calcium in a dairy permeate based hydration beverage is of benefit and provides a significant advantage over traditional sports drinks which contain little or no calcium at all. It is widely known that calcium is important for bone health and may provide other long-term health benefits yet many people are not getting enough of it from their diet.

Hydration beverages made from dairy permeates can provide significant levels of calcium. The current invention provides for approximately 160 mg of calcium per 16.9 oz serving (10% DV). As mentioned previously, if the permeate has been concentrated and reconstituted, the concentration levels of calcium may be adjusted even higher.

However, calcium is sensitive to heat and becomes less soluble in heated solutions. High acid environments help stabilize the calcium by helping to keep it soluble when heated. Thus, acidification to a pH level of <3.6 aids in the production of a shelf stable product because if the pH is 3.6 or greater, calcium and other mineral components will fall out with heat treatment.

Taste

It is well known that the taste of a beverage drives voluntary fluid intake. Common sense and research both indicate that palatable beverages naturally prompt people to drink more. During physical activity, taste preferences change dramatically compared to what we enjoy at rest. Physical activity alters the hedonic and descriptive characteristics of a beverage, an important consideration whenever fluid intake is of paramount importance. An effective hydration beverage has to reflect those differences. Sweetness level, tartness and flavor intensity, are characteristics that have to be properly balanced to optimize palatability in hot-and-sweaty conditions because the volume of beverage consumed during physical activity—and therefore hydration—is strongly related to the palatability of the beverage in those circumstances.

Physically active people prefer, and therefore drink more of, beverages that are lightly sweetened, moderately tart and citrus flavored.

While citrus flavors and other palatable flavors may be used to flavor dairy permeate, flavor alone may not provide a proper level of tartness to promote adequate voluntary fluid intake. To achieve the right taste profile and hedonic characteristics of a properly formulated hydration beverage, the dairy permeate must be acidified to achieve a proper balance between sweetness and tartness to encourage voluntary drinking.

Arrest Microbial Activity,

Furthermore, acidification helps arrest microbial activity in the permeate. Acidity plays a central role in the preservation of foods and combined with other factors such as heat, water activity, and chemical preservatives acts to prevent food deterioration and spoilage.

in the current invention, by lowering the pH below a 3.6 with citric acid, microbial activity is arrested in the dairy permeate thereby ensuring beverage stability and taste.

Lower Temperature for Heat Pasteurization

Furthermore, when heat pasteurization is applied to ensure shelf stability, the lower pH allows for the use of a lower temperature pasteurization process (hot fill) which helps to protect the integrity, taste and cost of the beverage.

The production of a hydration beverage must be compatible with optimizing product efficacy. For instance, issues such as the type of packaging and ergonomics of its use are important considerations, as they influence ease-of-use, voluntary fluid consumption, and consumer acceptance. Likewise, the limitations of heat processing and cost factors also interact to influence the type of pasteurization that will work best for a hydration beverage because they influence the taste, look and cost of the final beverage.

To avoid the use of chemical preservatives, which in addition to potentially causing negative health effects, can impart throat burn thereby decreasing voluntary fluid consumption, heat processing is required. By acidifying the dairy permeate and creating a high acid solution, the hydration beverage may be heat pasteurized using a “hot fill” process which requires a lower temperature heat to create a shelf stable product. Low acid solutions require UHT (ultra high temperature) pasteurization with aseptic filling. The former process causes minimal effect on color and flavor components and is overall a less expensive process while the latter can leave a burnt taste on the permeate, may cause browning and cost significantly more.

However, a UHT process with aseptic fill may be used to create a shelf stable hydration beverage made from permeate as well. Aseptic processing allows for the food to be properly sterilized outside the container and then placed into a previously sterilized container, which is then sealed in a sterile environment. A retort heating process may also be used.

Sodium

The inclusion of optimal levels of sodium chloride is a critical element in an effective hydration beverage. Sodium plays such a critical role in promoting fluid absorption, maintaining plasma volume, assuring rapid and complete rehydration, reducing urine production and stimulating voluntary fluid intake that its presence at the proper concentration in a hydration beverage can rightfully be considered indispensable.

The presence of adequate levels of sodium chloride affects both the flavor and the functional properties of a hydration beverage. In addition to promoting improved hydration, sodium chloride stimulates fluid consumption by maintaining the osmotic and volume-dependent stimuli for drinking, ensures ample sodium concentration in the intestinal lumen, provides an osmotic impetus for the maintenance of extracellular fluid volume and provokes adequate drinking and rehydration when fluid is consumed during and after physical activity.

A typical sweat sodium concentration ranges from 20-80 mmol/L. Ingesting sodium helps replace the sodium lost in sweat and stimulates osmotically depending dipsogenic factors that initiate further drinking. However, ingesting too much or too little sodium both discourages further drinking and impedes complete rehydration.

Sodium ingestion during exercise is also critical for the maintenance of plasma sodium levels and in helping to prolong exercise duration. The maintenance of plasma sodium by ingesting a sports drink at a rate similar to sweat loss helps extend exercise time to exhaustion and prevents hyponatremia.

In addition to stimulating drinking by taking advantage of organoleptic and osmotic factors, a carbohydrate-electrolyte beverage must be formulated to restore plasma volume without prompting a rapid decrease in plasma osmolality and resultant return to isotonicity. In doing so, more fluid is voluntarily ingested because the osmotic drive to drink is maintained. To accomplish this, a hydration beverage must contain a sodium concentration of 20-50 mmol/L.

Typically, milk contains 107 mg sodium per 1 cup (244 g) or 19.7 mMol/L/19.7 mEq/L. Milk permeate typically contains approximately 16.2 mMol/L/16.2 mEq/L sodium because some of milk's sodium is lost during ultrafiltration and sodium levels may be reduced further during the dilution of concentrated permeate. In order to ensure proper fluid absorption, sodium should be added so that the sodium concentration of the beverage is at least 20-50 mmol/L.

The current invention uses sea salt, a naturally derived form of sodium chloride, to increase sodium levels to 21 mmol/L (21 mEqL) but other common types of salt that may be used include but are not limited to sodium chloride (table salt), sodium citrate, sodium acetate and sodium acid sulfate.

Other Electrolytes

In addition to sodium, several other electrolytes are lost in sweat. Dairy permeates contain many of those electrolytes including potassium, magnesium, calcium, and phosphorus which contribute to whole-body hydration by providing an additional osmotic impetus to help the body hold onto the absorbed water molecules.

Flavoring

Dairy permeate is then flavored, preferably with flavoring systems from natural sources but any flavoring system may be used. The flavoring systems may include flavors such as lemon lime, fruit punch, citrus, berry, grape, cherry, pomegranate, watermelon, raspberry, orange or any other palatable flavor.

Carbohydrate

Dairy permeate can then be sweetened.

Beverage formulation affects the rate at which an ingested beverage exits the stomach (gastric emptying rate) and the speed at which fluid and nutrients enter the bloodstream from the proximal small intestine (absorption rate). Drinking enough fluid during exercise is the first step to prevent performance-sapping dehydration, but if that fluid is slowly absorbed or sits too long in the stomach, it does little to hydrate the body and can result in bloating, fullness, and nausea.

The active carbohydrate concentration of a hydration beverage must strike a delicate balance among the parameters of sweetness and taste, gastric emptying, intestinal absorption and fuel supply. Too little active carbohydrate will not optimize sweetness and taste characteristics and will not supply enough active carbohydrate to improve exercise performance.

Inactive carbohydrates, such as sugar alcohols, are not absorbed by the body, have a zero net carb effect and do not play a role in intestinal absorption or fuel supply.

Rapid gastric emptying—the speed at which fluid and nutrients leave the stomach for the small intestine where they are subsequently absorbed into the bloodstream—is an important characteristic of a properly formulated hydration beverage. If a hydration beverage contains too much carbohydrate it will slow gastric emptying, delaying the entry of fluid and nutrients into the body. Beverages containing 6% or less active carbohydrate (<6 g/100 ml) empty from the stomach as fast as plain water.

Once an ingested beverage exits the stomach and enters the proximal small intestine (duodenum and jejunum), the amount of active carbohydrate and the number and types of carbohydrate affect the rate of absorption into the bloodstream. Rapid absorption of water and nutrients in the small intestine occurs at carbohydrate concentrations of 6% or less; greater concentrations of carbohydrate are absorbed more slowly.

Increasing the concentration of active carbohydrate beyond 6% wt/vol provides little additional benefit and does not alter the rate of maximal carbohydrate oxidation. This means that there is potentially greater risk than benefit in increasing carbohydrate content of a sports drink above 6% wt/vol. Increasing the carbohydrate content of a sports drink risks reducing the gastric emptying and intestinal absorption rates and increasing the risks of gastrointestinal discomfort at no benefit and perhaps a detriment to performance.

For improved performance in exercise lasting 45 minutes or longer, athletes should consume a minimum of 20 grams of active carbohydrate each hour. Depending on the intensity and duration of the exercise, some athletes may need 30 to 90 grams per hour.

Dairy permeate typically have a carbohydrate concentration of 4.1-4.9% thus additional sugar may be used for sweetening up to the 6% active carbohydrate limit or the dairy permeate may be concentrated and reconstituted to a higher active carbohydrate rate. If the active carbohydrate rate of dairy permeate rises above 6%, dilution should be considered. Conversely, it follows that concentrated liquid or dry permeate should be reconstituted to no more than 6%. In addition to active carbohydrate rate, caloric content should also be considered so that total calories per serving to not exceed consumer expectation.

If the desired sweetness level is not met through the carbohydrate content alone, additional non-caloric or lower calories natural sweeteners such as monk fruit, stevia, erythrtitol and/or allulose or artificial sweeteners such as sucrose, aspartame or others may be used.

Consistent with this science, the present invention contains 4.4% carbohydrate (4.4 grams per 100 ml of fluid) and additional sweetness is provided with the addition of monk fruit and erythritol.

Further, ingesting multiple types of carbohydrates during exercise is associated with better performance, lower ratings of perceived exertion and less gastrointestinal distress compared to ingesting drinks containing only one carbohydrate. Providing a blend of carbohydrate types activates multiple transport mechanisms optimizes carbohydrate delivery and promotes fluid absorption in the small intestine.

The hydration beverage described herein can contain two carbohydrate sources: glucose and galactose, the components of the milk sugar lactose. Lactose, a disaccharide that occurs naturally in milk, is hydrolyzed 100%, or as close to 100% as possible wherein <0.1% lactose will remain in the finished product. Following hydrolysis, the monosaccharides glucose and galactose remain providing for easy digestion. Further, the glucose and galactose serve to stimulate the activity of the SGLT-1 membrane-bound transporter in the epithelium of cells in the proximal small intestine, ensuring rapid absorption of those two carbohydrates along with sodium molecules. Activation of the SGLT-1 transport system also stimulates transcellular and paracellular transport of other electrolytes and water.

Color

To improve the palatability of the beverage, commercially available coloring agents may be used. Colors derived from plant sources such as fruits and vegetables are preferred to keep the drink within the parameters of a natural hydration beverage containing no ingredients from artificial sources. Artificial colors may also be used.

Heat Pasteurization

Once the hydration beverage has been fully formulated as outlined above, the beverage will be heat pasteurized to provide a shelf life stability of several months to over a year.

In the method of manufacturing a hydration beverage described herein, a hot fill process is used wherein the beverage is heated to at least 175 degrees F. The bottle or container is then filled when the beverages is at least 170 degrees F. A cap or enclosure is applied and the temperature of the beverage is held at 170 degrees F. for a minimum of 30 seconds but no longer than 4 mins. The bottle is then cooled to room temperature.

Asceptic processing is an alternative for hydration beverage made from permeate with higher pH levels however the process may impart a burnt milk flavor taste as well as browning and may significantly increase the cost of production resulting in a beverage cost exceeding consumer expectation.

Variations:

While the present invention contemplates the use of milk permeate or whey permeate for the creation of a hydration beverage, another type of permeate-microfiltered milk, which contains whey protein may also be used in substitution of or in addition to the milk or whey permeates to create an effective hydration beverage. Milk whey protein is created when milk is filtered through a microfiltration membrane. The microfiltration membrane removes a majority of the milk's protein, specifically, the protein casein, leaving the whey protein in the permeate. Milk whey protein may be processed as set forth above to create a hydration beverage that contains protein which may be suitable to provide rehydration and muscle recovery following physical exertion.

Alternatively, a protein source may be added to milk permeate/ultra-filtered deproteinized milk or whey permeate to create a shelf stable sports nutrition beverage to provide recovery and rehydration.

Protein

The benefits of consuming protein following exercise training are well known. Post-exercise protein consumption is recommended because it has been shown to be effective at stimulating muscle protein synthesis, suppression of muscle protein breakdown and providing a net positive protein balance.

The size of skeletal muscle is dependent upon the kinetic processes of muscle protein synthesis (MPS) and muscle protein breakdown (MPB). The difference between the two determines net protein balance (NPB). When fluctuations in MPS equal those of MPB, muscle mass is maintained. When MPS exceeds MPB, NPB will be positive and muscle mass will grow.

Athletes can achieve a positive NPB by consuming protein following resistance exercise. When protein is ingested following resistance exercise there is an impact on MPS resulting in muscle growth. Just as importantly, especially for athletes competing in more than one event in a day, MPB will decreased, which can help prevent injury and ensure a more complete muscle recovery before a subsequent competition.

Several studies have suggested that 20 grams of high-quality protein is sufficient to maximally stimulate MPS and decrease MPB providing a positive NPB.

Rehydration

Often, people do not drink enough during exercise to prevent dehydration and rely on rehydration after physical activity to restore body fluids. When rapid rehydration is required, consuming a volume of fluid in excess of the existing water deficit along with adequate electrolytes and carbohydrates is knowns to optimize the rate and completeness of rehydration.

As discussed herein, ultra-filtered deproteinized milk or milk permeate, whey permeate microfiltered milk, and/or whey as outlined herein, provides an ample balance of fluids, electrolytes and carbohydrates to effectively rehydrate a dehydrated person quickly and completely.

It is well known that the taste of a beverage drives voluntary fluid intake. During physical activity, taste preferences change dramatically compared to what people enjoy at rest. Physical activity alters the hedonic and descriptive characteristics of a beverage, an important consideration whenever fluid intake is of paramount importance.

Many protein drinks are thick, opaque and heavy beverages which are not always desirable to consume in hot and sweaty conditions. Thus, to create a protein beverage that athletes will consume enough of to not only provide protein for recovery but enough fluids to provide complete rehydration, a transparent liquid that can be made into a refreshing beverage may be ideal.

A dairy permeate or whey can provide that refreshing base for a recovery beverage with the electrolytes and carbohydrates needed to provide fast and complete rehydration. Whey protein isolate is a high quality protein that has been shown to increase MPS and decrease MPB. Twenty grams of whey protein isolate has been shown to be a sufficient amount of protein to help increase NPB.

The sweetness level, tartness and flavor intensity of a recovery beverage made with a dairy permeate or whey can be properly balanced to optimize palatability in hot-and-sweaty conditions.

The beverage can include dairy permeate or whey and an acidification agent. The beverage will have a pH of less than 3.6. The beverage can be made shelf stable though a hot fill process.

Furthermore, the sports nutrition beverages outlined in the present invention may be fortified with additional calcium, protein, caffeine, amino acids or other nutritionals including but not limited to guarana, CBD oil, turmeric, herbs, carnitine, fish oils, probiotics, superfoods, green foods, MCT oil, creatine, etc.

Use of the Beverages:

The shelf stable dairy permeate based sports nutrition beverages may be ingested before, during or after exercise to replace the water and electrolytes lost in sweat or the beverages may be consumed therapeutically to replace water and electrolytes lost from vomiting or diarrhea or by the elderly to ensure proper hydration because that population often suffers from dehydration.

Additionally, if protein is included, the shelf stable sports nutrition beverages may be consumed following exercise for muscle recovery as well as rehydration. Individuals may also consume the sports nutrition beverage with protein to supplement daily nutritional needs.

Details of one or more embodiments are set forth in the accompanying drawings and description. Other features, objects, and advantages will be apparent from the description, drawings, and claims. Although a number of embodiments of the invention have been described, it will be understood that various modifications may be made without departing from the spirit and scope of the invention. It should also be understood that the appended drawings are not necessarily to scale, presenting a somewhat simplified representation of various features and basic principles of the invention.

1. A hydration beverage comprising:
a dairy permeate; and
an acidification agent;
wherein the beverage has a pH of less than 3.60;
wherein the beverage is shelf stable.

2. The hydration beverage of claim 1, wherein the dairy permeate is a milk permeate.

3. The hydration beverage of claim 1, wherein the beverage has a lactose concentration of 0.1% or less, a chloride concentration of about 20-40 mMol/L, the acidification agent includes citric acid

4. The hydration beverage of claim 1, wherein the beverage has a sodium ion concentration of about 10-50 mMol/L.

5. The hydration beverage of claim 3, wherein the concentration of citric acid provides for a pH of less than 3.6.

6. The hydration beverage of claim 1, wherein the sodium ion includes sodium added to the beverage as a sodium salt.

7. The hydration beverage of claim 6, wherein the sodium salt is sodium chloride, table salt, or sea salt.

8. The hydration beverage of claim 1, wherein the dairy permeate is used in its liquid form.

9. The hydration beverage of claim 1, wherein the dairy permeate is reconstituted from a liquid or dry concentrate.

10. The hydration beverage of claim 1, wherein the dairy permeate is a milk permeate (ultra-filtered deproteinized milk), whey permeate, microfiltered milk a/k/a native whey or the milk co-product whey.

11. The hydration beverage of claim 1, wherein the beverage has a carbohydrate component concentration of 6 wt % or less.

12. The hydration beverage of claim 1, wherein the carbohydrate component consists of a disaccharide or consists essentially of monosaccharides.

13. The hydration beverage of claim 1, wherein the carbohydrate concentration is less than 5 wt %.

14. The hydration beverage of claim 1, wherein the dairy permeate is substantially free of protein.

15. The hydration beverage of claim 1, wherein the beverage will be heat pasteurized to provide a shelf life stability of several months to over a year.

16. A method of making a hydration beverage comprising:
providing a dairy permeate or dairy co-product; and
adding an acidification agent;
wherein the beverage pH is lowered to less than 3.60,
wherein the beverage is heat pasteurized to provide shelf stability for several months or years.

17. The method of claim 16, further comprising concentrating the dairy permeate.

18. The method of claim 16, further comprising adding a sodium salt to the dairy permeate.

19. The method of claim 16, wherein the acidification agent includes citric acid.

20. The method of claim 16, wherein the acidification agent is used at a concentration that will provide for a pH of less than 3.6.

21. The method of claim 16, wherein the beverage is heat pasteurized to provide shelf stability.

22. The method of claim 16, wherein the beverage is heated to a minimum of 175 degrees F. (79.4° C.).

23. The method of claim 16, wherein the beverage is held at a minimum fill temperature of 170 degrees F. for a minimum of 30 seconds but no longer than 4 minutes.

24. A recovery and rehydration beverage comprising:
a dairy permeate; and
a protein source
an acidification agent;
wherein the beverage has a pH of less than 3.60;
wherein the beverage is shelf stable.

25. The recovery and rehydration beverage of claim 24, wherein the protein source includes liquid whey, whey protein, whey protein concentrate, whey protein isolate, casein, soy protein, plant-based protein, pea protein, insect protein or another protein source.

26. The recovery and rehydration beverage of claim 24, wherein the beverage contains about 10 g, 20 g, 25 g, 30 g, or 50 g of protein.
